(19) United States
(12) Patent Application Publication
(10) Pub. No.: US 2009/0194497 A1
(43) Pub. Date: Aug. 6, 2009

(54) Gantry with a Buffering Structure

(76) Inventor: Cheng-Feng LIN, Taichung (TW)

Correspondence Address: Dr. BANGER SHIA, 102 Lindencrest Ct., Sugar Land, TX, 77479-5201, US

(21) Appl. No.: 12/025,043

(22) Filed: Feb. 3, 2008

(51) Int. Cl. B66C 13/06

(52) U.S. Cl. 212/272

(57) ABSTRACT

A gantry with a buffering structure cooperates with a base and comprises a gantry and a buffering structure. Both ends of the gantry are provided with a connecting portion, respectively. One of the connecting portions is fixed on the base, and the buffering structure is disposed between the other connecting portion of the gantry and the base. Thereby, when the gantry moves along with the base, the gantry can absorb the inertial strength caused by displacement and the deformation caused by thermal expansion and contraction by the flexibility of the buffering structure.

### BACKGROUND OF THE INVENTION

1. Field of the Invention

The present invention relates to a gantry structure, and more particularly to a gantry with a buffering structure.

2. Description of the Prior Art

Automatic platforms can save manpower and quicken the manufacturing process, and the design of the platforms must consider the environment and the shape of the products. Thereby, a displacement platform 90 of a gantry appeared in the market, which comprises a gantry 91 and a base 92. The gantry is mounted on the base 92.

However, such a conventional displacement platform of a gantry still has the following disadvantages:

The gantry 91 is fixed on the base 92 by a plurality of screws, or by screws and nuts, or by positioning pins. The gantry 91 associated with the above-mentioned methods are all fixed to the base 92, once being fixed, it cannot be adjusted anymore. Therefore, if the gantry 91 is positioned imprecisely, the problem of angle deflection will occur. In addition, when the gantry 91 moves, it will cause the problem of asynchronous movement.

Moreover, when the gantry 91 is used in the environment where temperature change is very big, a physical phenomenon of thermal expansion and contraction will be produced. As a result, the gantry 91 is deformed, such that when the gantry 91 moves, it will cause the problem of asynchronous movement.

The present invention has arisen to mitigate and/or obviate the afore-described disadvantages.

### SUMMARY OF THE INVENTION

The primary objective of the present invention is to provide a gantry with a buffering structure which can absorb the error.

To achieve the objective of the present invention, the gantry with a buffering structure cooperates with a base and comprises a gantry and at least one buffering structure. Both ends of the gantry are provided with a connecting portion, respectively. One of the connecting portions is fixed on the base, and the buffering structure is disposed between the other connecting portion of the gantry and the base.

The buffering structure includes a sliding block and a guide rail. The sliding block is slidably disposed on the guide rail. A top of the sliding block is fixed to the other connecting portion of the gantry, and a bottom of the guide rail is fixed on the base.

The guide rail of the buffering structure is parallel to the gantry, and the sliding block of the buffering structure is vertical to the direction in which the base moves.

Thereby, the gantry can absorb the inertial strength caused by displacement and the deformation caused by thermal expansion and contraction by the flexibility of the buffering structure.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional displacement platform of a gantry;

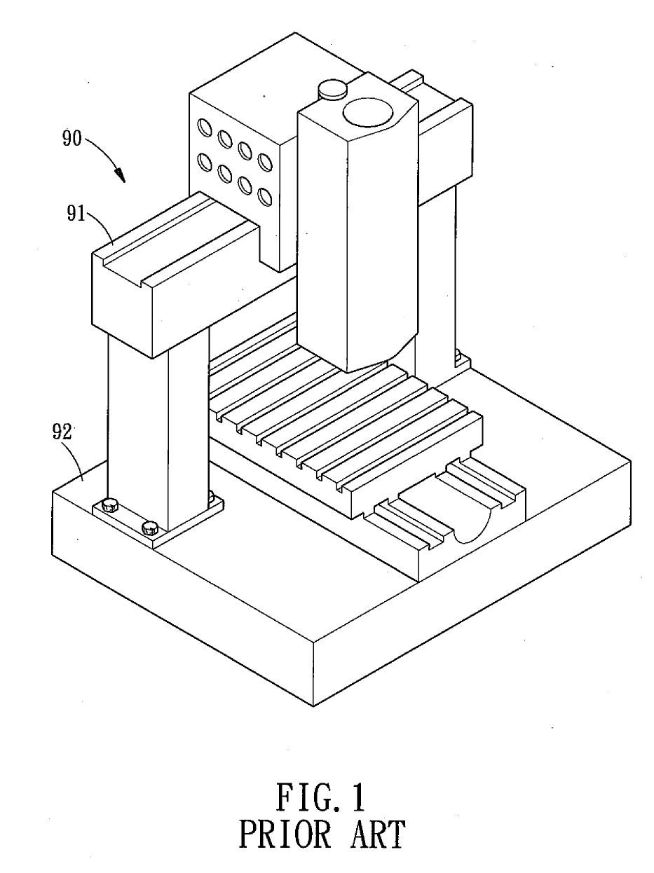

FIG. 2 is an exploded view of a gantry with a buffering structure in accordance with the present invention;

FIG. 3 is an assembly perspective view of the gantry with a buffering structure in accordance with the present invention; and

FIG. 4 is a partial amplified view of the gantry with a buffering structure in accordance with the present invention.

### DETAILED DESCRIPTION OF THE PREFERRED EMBODIMENTS

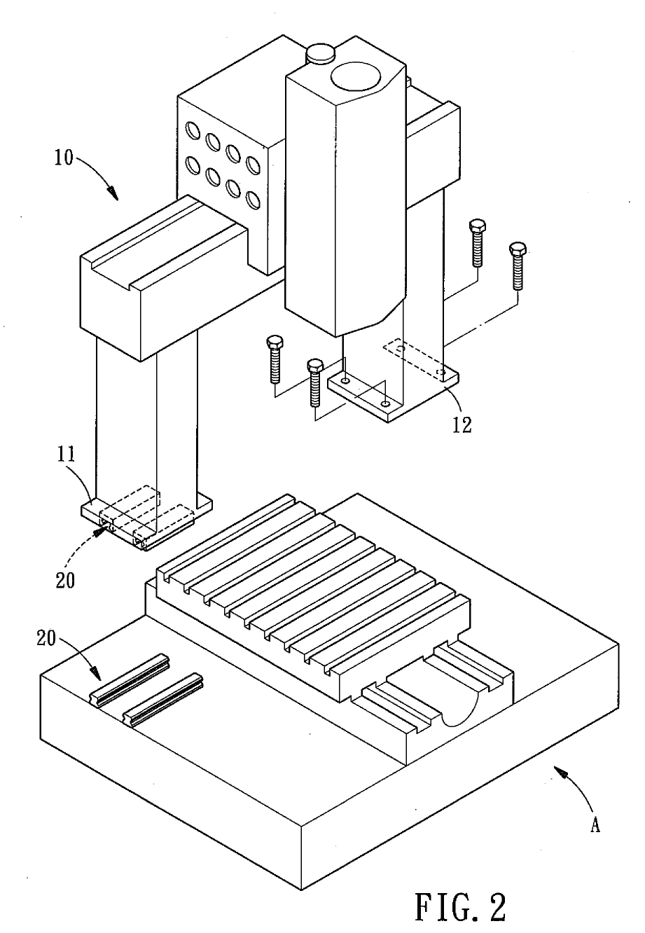

Referring to FIG. 2, a gantry with a buffering structure in accordance with the present invention comprises a gantry 10 and a buffering structure 20.

Both ends of the gantry 10 are provided with connecting portions 11 and 12. The gantry 10 is mounted on a base A. The connecting portion 11 of the gantry 10 is fixed on the base A (such as fixed by locking, engaging or inserting), and the buffering structure 20 is disposed between the connecting portion 12 of the gantry 10 and the base A.

The buffering structure 20 includes a sliding block 21 and a guide rail 22. The sliding block 21 is slidably disposed on the guide rail 22. A top of the sliding block 21 is fixed to the connecting portion 12 of the gantry 10, and a bottom of the guide rail 22 is fixed on the base A. The guide rail 22 of the buffering structure 20 is parallel to the gantry 10, and the sliding block 21 of the buffering structure 20 is vertical to the direction in which the base A moves.

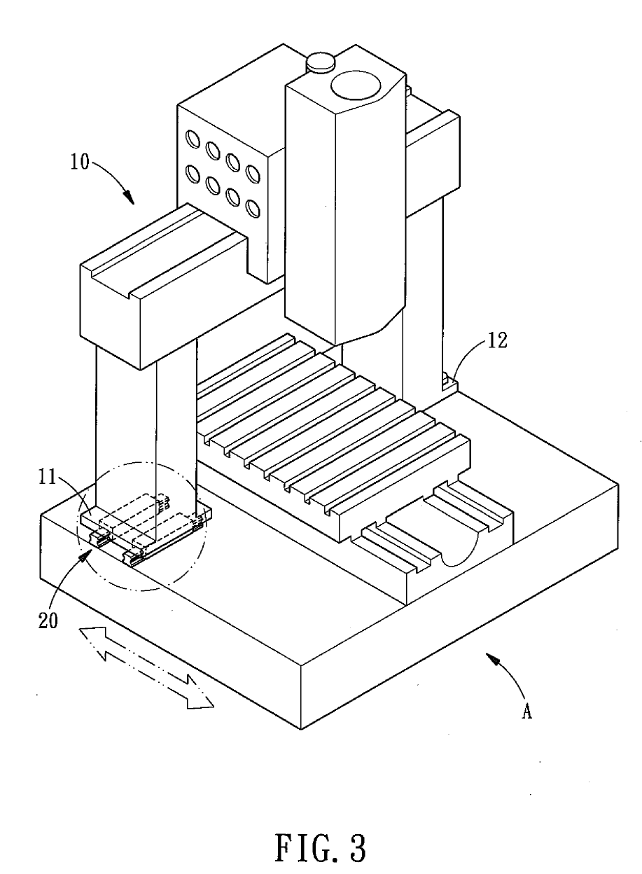

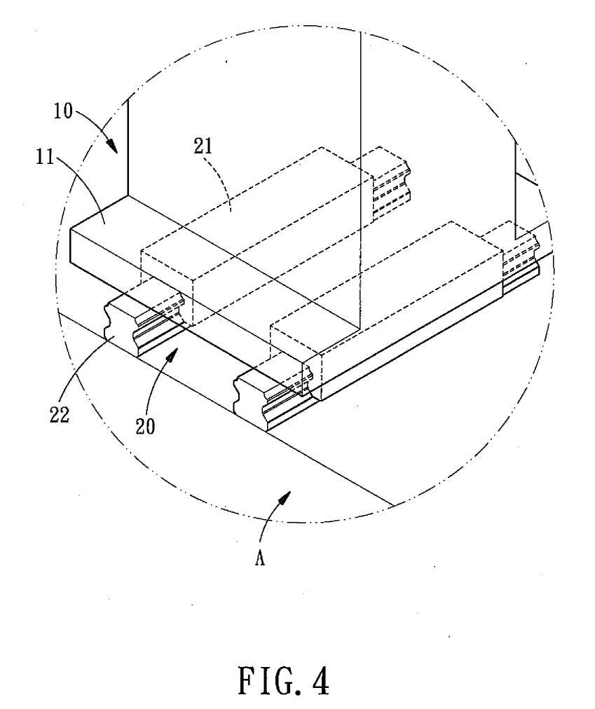

For a better understanding of the present invention, its operations and functions, reference should be made to FIGS. 3 and 4:

When the base A moves, and one end of the gantry 10 is fixed on the base A, the other end of the gantry 10 will absorb the error caused by displacement or environment by the flexibility of the buffering structure 20.

To summarize, the gantry with a buffering structure of the present invention cooperates with the base and comprises the gantry and the buffering structure. Both ends of the gantry are provided with a connecting portion, respectively. One of the connecting portions of the gantry is fixed on the base, and the buffering structure is disposed between the other connecting portion of the gantry and the base. Thereby, when the gantry moves along with the base, the gantry can absorb the inertial strength caused by displacement and the deformation caused by thermal expansion and contraction by the flexibility of the buffering structure.

While we have shown and described various embodiments in accordance with the present invention, it should be clear to those skilled in the art that further embodiments may be made without departing from the scope of the present invention

What is claimed is:

1. A gantry with a buffering structure cooperating with a base, comprising:
a gantry, both ends of the gantry being provided with a connecting portion, respectively, one of the connecting portions of the gantry being fixed on the base; and
at least one buffering structure disposed between the other connecting portion of the gantry and the base.

2. The gantry with a buffering structure as claimed in claim 1, wherein the buffering structure includes a sliding block and a guide rail, the sliding block is slidably disposed on the guide rail, a top of the sliding block is fixed to the other connecting portion of the gantry, and a bottom of the guide rail is fixed on the base.

3. The gantry with a buffering structure as claimed in claim 2, wherein the guide rail of the buffering structure is parallel to the gantry, and the sliding block of the buffering structure is vertical to a direction in which the base moves.
